(19) United States
(12) Patent Application Publication
(10) Pub. No.: US 2010/0161240 A1
(43) Pub. Date: Jun. 24, 2010

(54) TEST STRIP AND DEVICE FOR MEASURING SAMPLE PROPERTIES AND SYSTEM INCORPORATING THE SAME

(76) Inventor: Chao-Man Tseng, Wuku Hsiang (TW)

Correspondence Address: HOLLAND & HART, LLP, P.O BOX 8749, DENVER, CO, 80201, US

(21) Appl. No.: 12/369,127

(22) Filed: Feb. 11, 2009

Related U.S. Application Data
(60) Provisional application No. 61/140,726, filed on Dec. 24, 2008.

(51) Int. Cl. G06F 19/00

(52) U.S. Cl. 702/22

(57) ABSTRACT

A test strip for use in measuring sample properties, a device for use with the test strip, and a system incorporating the same. The test strip includes a sample receiving portion and a plurality of electrodes extending along an electrode plane and intersecting with the sample receiving portion. The test strip also includes a contact plane oriented orthogonal to the electrode plane and including a plurality of planar contacts adapted to conductively interface with the meter's connector when urged against the connector in a direction normal to the contact plane. The contacts encode information pertaining to characteristics of the test strip. The contacts may be sized and spaced in order to encode the information. Also, the contacts may be insulated in order to encode the information.

### BACKGROUND

Doctors and patients alike often have cause to monitor a variety of bodily fluids such as blood, saliva, or urine. For instance, a patient's blood is often monitored for the presence of high levels of glucose or cholesterol. In the case of a diabetic patient, glucose is closely monitored to ensure that glucose levels remain as close to normal as possible. There are a number of convenient devices, known as glucose meters that allow people to monitor their blood glucose levels. These devices typically employ a test strip to which the user applies a small drop of blood. The test strip typically includes a chamber that contains reagents, such as glucose oxidase and a mediator. There are two types of monitoring devices, photometric based and electrochemical based. The photometric based system is generally considered to be older technology. Currently, the more preferred meter technology is the electrochemical based system that applies a voltage to electrodes included in the test strip thereby causing a redox reaction in the glucose/reagents. The meter then measures the resulting current and calculates the corresponding glucose level.

Due to manufacturing variation test strips manufactured over time will have different characteristics which may affect the accuracy of meter readings. For this reason test strips are often manufactured in lots. Information relating to the characteristics of a particular lot is correlated to a lot number or code. This information may then be used by the glucose meter to adjust for the characteristics of a particular test strip and thereby provide more accurate readings.

Various methods for communicating the lot specific information to the meter's processor have been devised. For instance, a code representing values for various parameters may be manually input into the meter by the user. This is an inconvenient and error prone means of calibrating the meter for the test strips. Bar-codes have also been used in the past to encode information relating to the test strip's characteristics. Printing a bar-code on each strip adds significant manufacturing costs to test strip production and requires that the meter include the additional expense and complexity of a bar-code reader.

An improvement over the manual input and bar code methods is described in United States Patent Application No. 2007/0015286 entitled DIAGNOSTIC STRIP CODING SYSTEM AND RELATED METHODS OF USE. As shown in prior art FIGS. 1 and 2 the system includes a meter having a connector 12 including contacts 1-9. Connector 12 receives the end of test strip 10 such that contacting pads 1′-9′ are operatively connected to contacts 1-9. Through this operative connection, the meter is presented with, and reads from the contacting pads, a particular code signaling the meter to access information related to a particular underlying test strip 10. In this case the code is comprised of pads 5′-9′. Pads 1′-4′ are connected to a sample chamber on the opposite end of the test strip. The code is illustrated in FIG. 2, where conductive contacting pads 6′ and 8′ are overprinted with an electrical insulating material, such as, for example, a non-conductive ink layer 14. Accordingly, contacts 5-9 communicate the code to a processor within the meter that adjusts its calculations.

While the system described with respect to FIGS. 1 and 2 is an improvement over other means of providing test strip specific information to a test meter, there is still room for improvement. In particular the connector contacts described above are prone to damage. Additionally, to ensure proper connection, a button or spring contact is required to apply contact force between the test strip and test meter. Furthermore, these are sliding contacts that are susceptible to wear. In addition, the contacts are more complex to manufacture especially to the extent to which the metallic contacts are molded into a housing or socket. The test strip is also difficult to manufacture and may be limited in the number of pads that can be located on a reasonably sized test strip, thereby limiting the number of code combinations and density of information that can be communicated to the meter.

Accordingly, there is a need for a test strip for use in measuring sample properties, a device for use with the test strip, and a system incorporating the same that is more durable, less expensive to manufacture, and capable of more code combinations.

### SUMMARY

The exemplary embodiment described herein is directed to a test strip for use in measuring sample properties, a device for use with the test strip, and a system incorporating the same. The test strip includes a sample receiving portion and a plurality of electrodes extending along an electrode plane and intersecting with the sample receiving portion. The test strip also includes a contact plane oriented orthogonal to the electrode plane and including a plurality of planar contacts adapted to conductively interface with the meter's connector when urged against the connector in a direction normal to the contact plane. The contacts encode information pertaining to characteristics of the test strip. The contacts may be sized and spaced in order to encode the information. Also, the contacts may be insulated in order to encode the information.

The device, or meter, for use with the test strip includes a socket sized and configured to receive the test strip. The connector is housed in the socket and adapted to conductively interface with the planar contacts of the test strip when it is urged against the connector. The connector may be an elastomeric connector. The socket may also include a plurality of electrode contacts each operative to conductively interface with a corresponding one of the electrodes.

The meter also includes a processor for performing calculations on the readings coming from the electrodes and adjusting the calculations based on the particular characteristics of the test strip. The processor is supported on a circuit board that includes a plurality of conducting pathways interconnecting the processor with the connector. Thus, when the planar contacts interface with the connector, information pertaining to the test strip is registered by the processor and the calculations may be corrected as necessary.

The foregoing and other features, utilities, and advantages of the invention will be apparent from the following more particular description of the embodiment of the invention as illustrated in the accompanying drawings.

### BRIEF DESCRIPTION OF THE DRAWINGS

The accompanying drawings, which are incorporated in and constitute a part of this specification, illustrate an embodiment of the present invention and together with the description, serve to explain the principles thereof. Like items in the drawings are referred to using the same numerical reference.

FIG. 1 is a top plan view of a prior art connector configured to receive a corresponding test strip;

FIG. 2 is a partial top plan view of a prior art test strip for use with the connector shown in FIG. 1;

FIG. 3 is a perspective view of an exemplary embodiment of a system for measuring a sample property;

FIG. 4 is a perspective view of the system shown in FIG. 3 with the test strip inserted into the socket;

FIG. 5 is an enlarged partial perspective view of the socket shown in FIGS. 3 and 4 with the socket shown transparent;

FIG. 6 is an enlarged partial perspective view of the connector shown in FIG. 5;

FIG. 7A is a partial top plan view of the test strip contacts aligned with the connector;

FIG. 7B is a partial top plan view of the test strip contacts misaligned with the connector;

FIG. 8A is a partial perspective view of the test strip contacts;

FIG. 8B is a partial perspective view of the test strip shown in FIG. 8A with one of the contacts removed;

FIG. 9 is a partial perspective view of a test strip illustrating an alternative construction of test strip contacts;

FIG. 10 is a partial perspective view of a test strip illustrating another alternative construction of test strip contacts;

FIG. 11 is a partial perspective view of a test strip illustrating yet another alternative construction of test strip contacts; and

FIG. 12 is a perspective view of a system for measuring a sample property illustrating the test strip interfacing with the connector from different sides.

### DETAILED DESCRIPTION

The technology of the present application will be explained with reference to the figures. While the technology is explained with particular reference to certain devices and materials, it should be understood that those devices and materials are exemplary in nature and should not be construed as limiting. The test strip measurement system disclosed herein includes a test strip code interface that is more robust, less expensive to manufacture, and capable of more code combinations than conventional coding systems. While the coding system is described with respect to a test strip measurement system, one ordinarily skilled in the art will recognize that this system could be implemented anywhere it is desired to encode a strip, card, or other card like object. Such objects may include, for example and without limitation keys, card keys, identification badges, memory sticks, and the like.

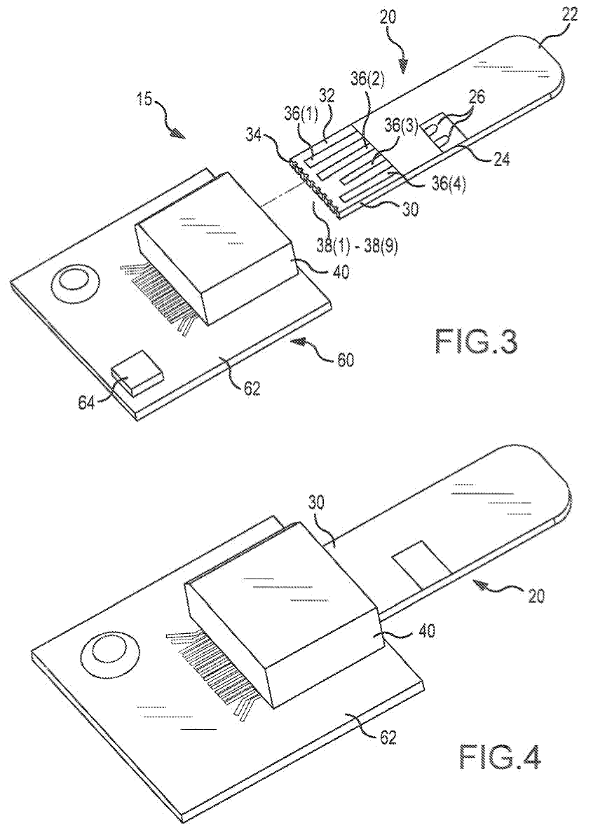

An exemplary embodiment of a test strip measurement system 15 is shown in FIGS. 3 and 4. Test strip measurement system 15 includes test strip 20 and measuring device 60. Test strip 20 includes handle portion 22, sample receiving portion 24, and interface portion 30. In this case, sample receiving portion 24 is in the form of a fluid chamber. Also in this case, system 15 is represented as an electrochemical based system for detecting blood glucose. This system could also be implemented for detecting uric acid, cholesterol, triglycerides, and ketones, to name a few.

Measurement electrodes 36 extend along electrode plane 32 and intersect with chamber 24. Some of the electrodes may include measurement contacts 26 disposed within chamber 24. These electrodes electrically interface with measuring device 60 for analysis of a sample under test. The electrodes may include fill detect electrodes, working electrodes, and counter electrodes, for example. It should be understood that the number and type of electrodes and measurement contacts shown and described herein is merely exemplary, and the system may include fewer or more electrodes depending on the desired measurements and type of system. Furthermore, the system is not limited to electrode test strips but would also be suitable for other diagnostic test strips, such as photometric test strips and the like.

Interface portion 30 also includes a plurality of code contacts 38(1)-38(9) disposed on contact plane 34, which lies orthogonally to electrode plane 32. These contacts may be configured to provide a code that is read by measuring device 60. The code is operative to communicate information pertaining to characteristics of the test strip. For example, this code may be used to access stored information in the measuring device 60, and/or it may represent one or more values that relate to calibration characteristics of the test strip.

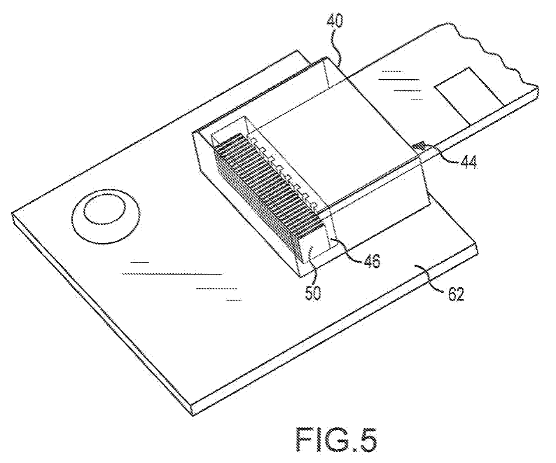

Measuring device 60 includes printed circuit board (PCB) 62 which supports processor 64 and socket 40. It can be appreciated that socket 40 may be mounted to PCB 62 with suitable mounting holes and fasteners (not shown). Suitable alignment pins (not shown) may also be included to ensure that connector 50 is properly aligned to conductive pathways or traces 66 and 67. It can be seen in FIG. 5 that socket 40 includes an opening shown here in the form of slideway 44, which is sized and configured to receive interface portion 30 of test strip 20. Socket 40 also includes pocket 46, which is sized and configured to receive connector 50. When interface portion 30 of test strip 20 is urged into slideway 44 in a direction normal to contact plane 34, contacts 38 conductively interface with connector 50.

Connector 50 in this case is an elastomeric connector. Elastomeric or silicone rubber compression connectors are made with alternating layers of conductor 52 and insulator 54 materials. Compression connectors are so called because they are clamped to or otherwise compressed or held under pressure between the two electrical contacts for making electrical connection therebetween. These connectors have the desirable characteristic of being compliant and compressible due to the characteristics of the silicone rubber, and so can accommodate variations in flatness and tolerances of the contact pads on the circuit board and test strip to which they make electrical connection.

Advantageously, the compressible conductor provides a device where the force of the user inserting the test strip into the test meter provides the contact force between the plurality of code contacts and the connector 50. This allows great simplification and cost reduction in the design and manufacturing of the test meter and/or test strip in that additional spring contacts or push button contacts are not needed to provide contact force between the test strip and the test meter.

Also, as illustrated in FIG. 12, the elastomeric or silicone rubber connector has multiple surfaces against which the test strip may be urged or pressed in order to conductively interface with the connector. For example, in this case the test strip may be urged against either side or from the top of connector 50. It should be appreciated that even though the connector is shown in the exemplary embodiment to have a square cross-section, connector 50 could be configured with other cross-sections, such as triangular, rectangular, polygonal, as well as round like shapes.

The conducting layer 52 of a typical elastomeric connector is made from a silicone rubber dielectric matrix that is filled with carbon, silver, gold or other conductive material. The use of silicone rubber for both dielectric and conductor layers provides for proper bonding of the layers and good mechanical strength. Elastomeric or silicone rubber connectors are available from several manufacturers such as Fujipoly America Corporation of Carteret, N.J. (www.fujipoly.com) and Z-axis Connector Company of Warminster, Pa. (www.z-axiscc.com).

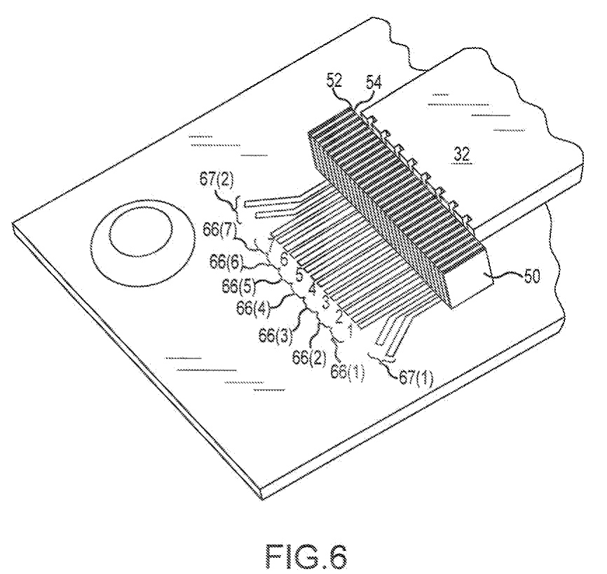

With reference to FIGS. 5 and 6 it can be seen that connector 50 is clamped in pocket 46 against PCB 62 making contact with conductive pathways 66 and 67. One manufacturer recommends clamping the elastomeric connector such that it is compressed between 5%-25% of its height.

Conductive pathways 66 and 67 are open circuits connected to processor 64. Processor 64 detects which circuits are closed. The layer density of connector 50 is greater than the density of both pathways 66 and 67 as well as contacts 38. Thus, when interface portion 30 is inserted into slideway 44 contacts 38 conductively interface with connector 50 and at least one conductive layer will connect matched contacts and pathways and at least one insulating layer will isolate adjacent circuits, thereby closing the otherwise open circuits formed by pathways 66 and 67. In this case 67(1) and 67(2) are calibration circuits which the processor can read to ensure that contact plane 34 and associated contacts 38 are properly aligned to connector 50. Processor 64 can verify that the test strip 20 has been inserted properly when both calibration circuits 67(1) and 67(2) are closed by contacts 38(1) and 38(9).

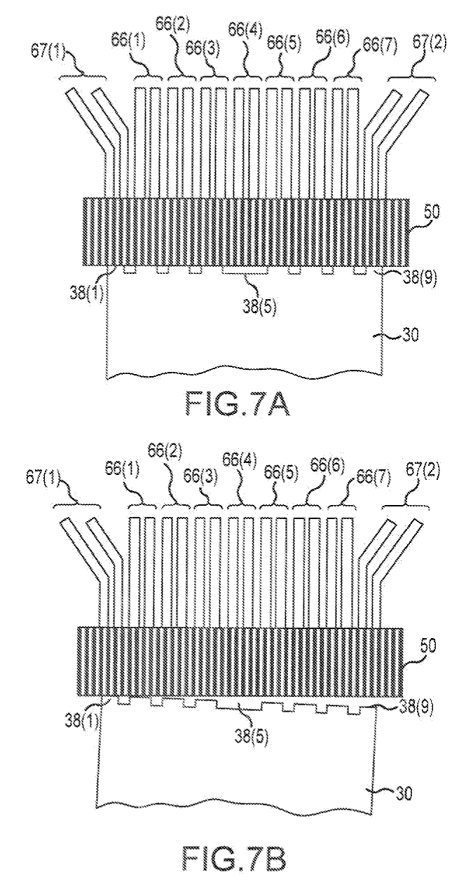

This may be best appreciated with reference to FIGS. 7A and 7B. In FIG. 7A interface portion 30 is properly inserted, thus contacts 38(1) and 38(9) complete the circuits 67(1) and 67(2) thereby indicating proper alignment of contact plane 34 with connector 50. FIG. 7B illustrates an improper insertion of interface portion 30 whereby contact 38(9) does not make proper contact with connector 50 and calibration circuit 67(2) remains open indicating improper insertion. Measurement device 60 may also include an indicator to alert a user whether or not the test strip is inserted correctly. Circuits 67(1) and 67(2) may also be used to activate wake-up logic in the measuring device.

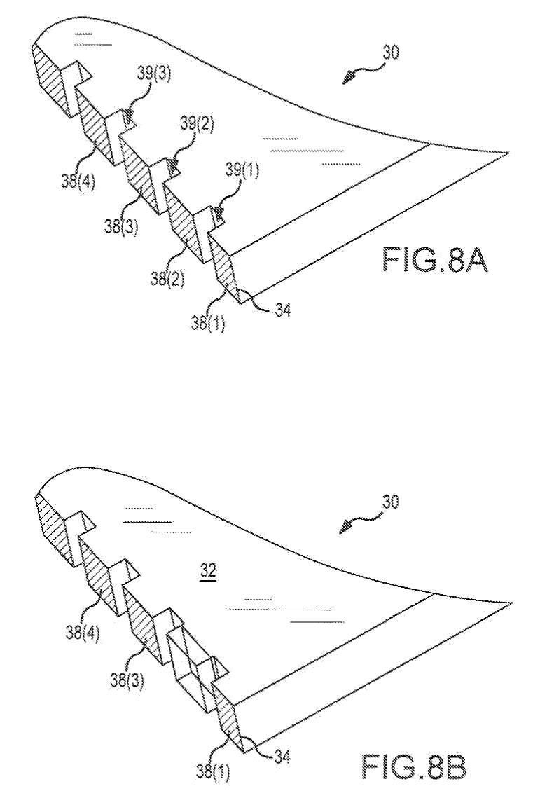

FIGS. 7A and 7B also illustrate an example of a code that might be used to convey information about the test strip. In this case contact 38(5) has been removed, thus circuit 66(4) will remain an open circuit thereby communicating to processor 64 a particular code associated with the test strip 20. In this case the code is created by removing the conductive material from one of the contacts. For example, in FIG. 8A, interface portion 30 includes a plurality of contacts including 38(1)-(3). Each of these contacts includes conductive material disposed thereon. This material may be printed, silk-screened, plated, or otherwise adhered or attached to contact plane 34. Also, between each contact there may be a notched region 39 which isolates the contacts from each other and facilitates removal of individual contacts. The test strip may be molded from a suitable plastic material. Notches 39 may be conveniently formed into the test strip during the molding process.

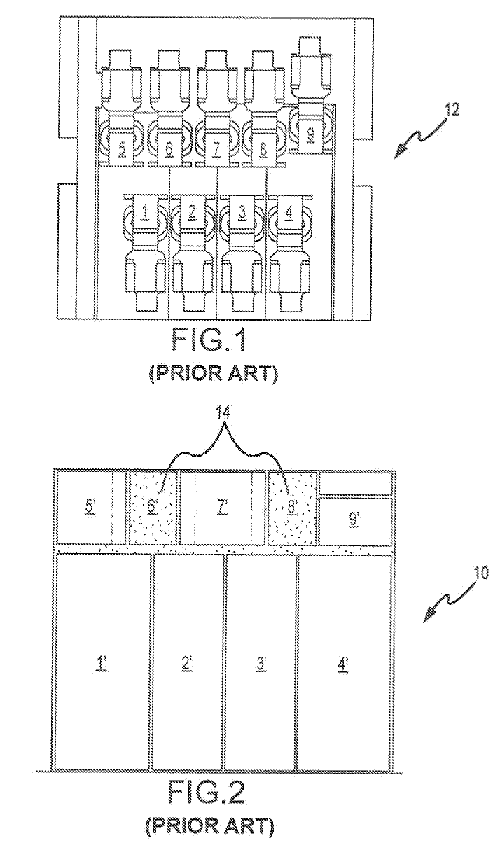

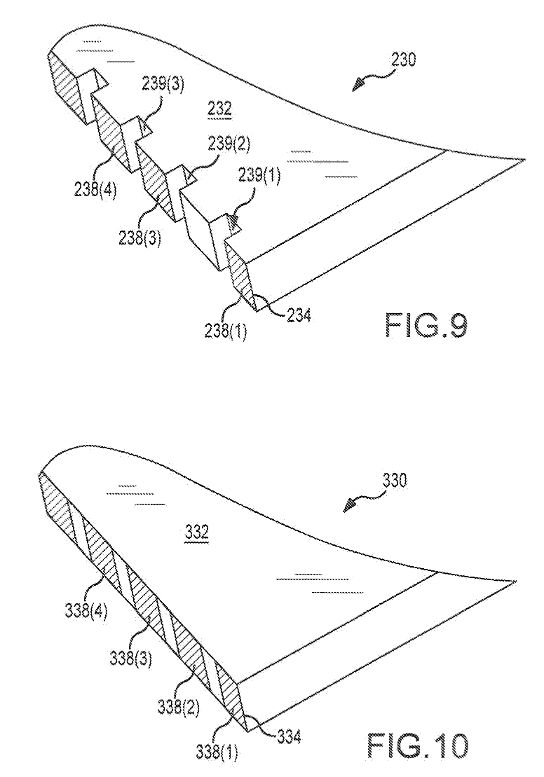

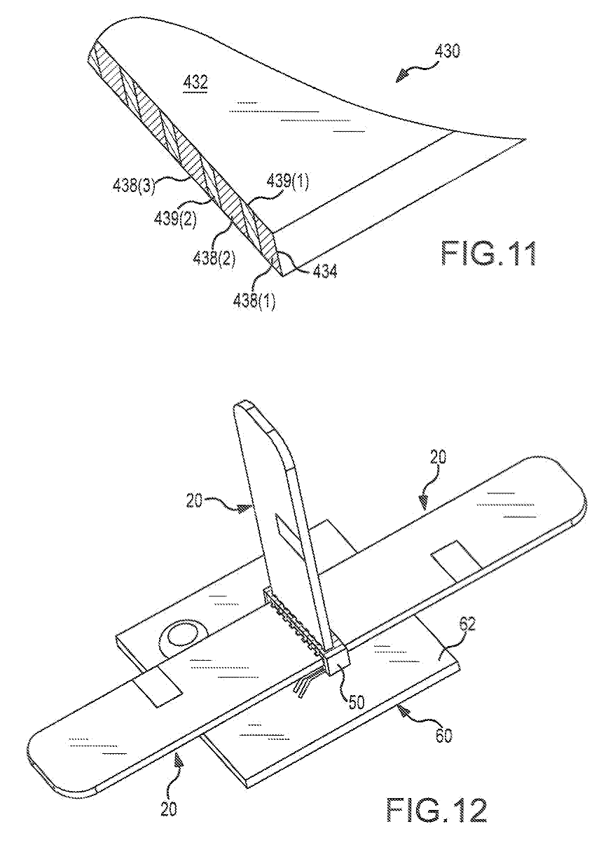

With further reference to FIG. 8B it can be appreciated that different codes can be created by removing one or more of the contacts, in this case contact 38(2). As one ordinarily skilled in the art will appreciate, the contact(s) may be removed by a punching process, grinding, or the like. Alternatively, as shown in FIG. 9, interface portion 230 may include contact plane 234 with notched regions 239. In this case the desired code could be created simply by not applying conductive material to a particular region or by covering up the conductive material with an insulator such as insulating ink or stickers, for example. FIG. 10 illustrates another alternate construction of interface portion 330. In this construction there are no notched regions. Contacts 338 are simply printed in spaced relation to each other along contact plane 334. Alternatively, as shown in FIG. 1 the entire contact plane 434 could be printed with conductive material and regions 439 could be printed with insulating ink or covered with stickers. An ordinarily skilled artisan will appreciate that using an elastomeric connector along with the described means of encoding the test strip provide a robust and reliable method of reading information from a test strip. Furthermore, the density of contacts 38 and pathways 66 can be greater than that possible with conventional test strips. Thus a greater number of code combinations are possible with the disclosed system.

Methods relating to the above described test strip and test strip measurement system are also contemplated. The methods thus encompass the steps inherent in the above described mechanical structures. Broadly, one method could include the step of providing a test strip having a combination of conductive contacts, which encode particular characteristics of the test strip. Next, the test strip contacts are urged in a direction normal to the plane in which the contacts lie against an elastomeric connector such that a processor connected thereto can read the combination of conductive contacts. Methods for encoding the test strip are also contemplated. For instance, the test strip could be formed with a plurality of notches defining a plurality of contact surfaces. Next, the contact surfaces are coated with a conductive material. Then selected contacts could be removed by punching, or otherwise, to create a combination of contacts that is indicative of test strip characteristics.

Accordingly, the present invention has been described with some degree of particularity directed to the exemplary embodiment. It should be appreciated, though, that the present invention is defined by the following claims construed in light of the prior art so that modifications or changes may be made to the exemplary embodiment without departing from the inventive concepts contained herein.

What is claimed is:

1. A test strip for use in measuring a sample property comprising:
a sample receiving portion;
a plurality of electrodes intersecting with said sample receiving portion extending in an electrode plane; and
a contact plane angled with respect to the electrode plane including a plurality of contacts adapted to conductively interface with a connector when urged against the connector in a direction normal to said contact plane.

2. A test strip according to claim 1 wherein said contacts are sized and spaced to encode information pertaining to said test strip.

3. A test strip according to claim 1 wherein selected ones of said contacts are insulated to encode information pertaining to said test strip

4. A test strip according to claim 1 wherein said electrodes extend along an electrode plane and said contact plane is orthogonal to said electrode plane.

5. A test strip according to claim 1 wherein said contacts are planar.

6. A test strip according to claim 1 wherein the contact plane is approximately orthogonal to the electrode plane.

7. A test strip according to claim 6 where the contact plane is orthogonal to the electrode plane.

8. A test strip according to claim 1 wherein said sample receiving portion is in the form of a fluid chamber.

9. A device for use with a test strip for measuring a sample property, wherein the test strip includes a plurality of electrodes in an electrode plane intersecting with a sample receiving portion, and a contact plane substantially perpendicular to the electrode plane including a plurality of planar contacts, said device comprising:
a connector adapted to conductively interface with the planar contacts when the test strip is urged against said connector in a direction normal to the contact plane;
a processor; and
a circuit board including a plurality of conducting pathways interconnecting said processor with said connector, whereby when the planar contacts interface with said connector information pertaining to the test strip is registered by said processor.

10. A device according to claim 9 wherein said connector is an elastomeric connector.

11. A device according to claim 10 wherein said connector is housed in a socket sized and configured to receive the test strip.

12. A device according to claim 11 wherein said socket includes a plurality of electrode contacts each operative to conductively interface with a corresponding one of the electrodes.

13. A system for measuring a sample property comprising:
a test strip including:
a sample receiving portion;
a plurality of electrodes extending along an electrode plane and intersecting with said sample receiving portion; and
a contact plane approximately orthogonal to the electrode plane and including a plurality of planar contacts; and
a device including:
a connector adapted to conductively interface with said planar contacts when the test strip is urged against said connector in a direction normal to the contact plane;
a processor; and
a circuit board including a plurality of conducting pathways interconnecting said processor with said connector, whereby when said planar contacts interface with said connector information pertaining to the test strip is registered by said processor.

14. A system according to claim 13 wherein said contacts are sized and spaced to encode information pertaining to said test strip.

15. A system according to claim 13 wherein selected ones of said planar contacts are insulated to encode information pertaining to said test strip

16. A system according to claim 13 wherein said connector is an elastomeric connector.

17. A system according to claim 16 wherein said connector is housed in a socket sized and configured to receive the test strip.

18. A system according to claim 17 wherein said socket includes a plurality of electrode contacts each operative to conductively interface with a corresponding one of the electrodes.

19. A test strip for use in detecting a sample property comprising:
a sample receiving portion;
a contact plane including a plurality of contacts adapted to conductively interface with a connector when urged against the connector in a direction normal to said contact plane, wherein said contacts are operable to encode information pertaining to said test strip.

20. A test strip according to claim 19 wherein said test strip is an electrochemical test strip.

21. A test strip according to claim 19 wherein said test strip is a photometric test strip.

22. A device for reading a code from a card, wherein the card includes a contact plane including a plurality of planar contacts, said device comprising:
an elastomeric connector adapted to conductively interface with the planar contacts when the card is urged against said connector in a direction normal to the contact plane;
a processor; and
a circuit board including a plurality of conducting pathways interconnecting said processor with said connector, whereby when the planar contacts interface with said connector the code is registered by said processor.
